(19) United States
(12) Patent Application Publication
(10) Pub. No.: US 2026/0079307 A1
(43) Pub. Date: Mar. 19, 2026

(54) OPTICAL CONNECTION ASSEMBLY, OPTICAL CONNECTION COMPONENT, AND METHOD OF MANUFACTURING OPTICAL CONNECTION ASSEMBLY

(71) Applicant: SUMITOMO ELECTRIC INDUSTRIES, LTD., Osaka (JP)

(72) Inventors: Eiichiro YAMADA, Osaka (JP); Yuto FUJIHARA, Osaka (JP)

(73) Assignee: SUMITOMO ELECTRIC INDUSTRIES, LTD., Osaka (JP)

(21) Appl. No.: 19/286,412

(22) Filed: Jul. 31, 2025

(30) Foreign Application Priority Data
Sep. 18, 2024 (JP) 2024-160759

(51) Int. Cl. G02B 6/38

(52) U.S. Cl. CPC G02B 6/3885; G02B 6/3825; G02B 6/3883

(57) ABSTRACT

An optical connection assembly of the present disclosure includes a first optical connection component, a second optical connection component configured to be connected to the first optical connection component, and a positioning structure configured to maintain relative positions between the first optical connection component and the second optical connection component. The positioning structure includes a protrusion protruding from the first optical connection component, and a hole formed in the second optical connection component and into which the protrusion is inserted. An inner surface of the hole includes at least one projection projecting from the inner surface toward the protrusion.

### CROSS REFERENCE TO RELATED APPLICATIONS

This application claims priority based on Japanese Patent Application No. 2024-160759 filed on Sep. 18, 2024, and the entire contents of the Japanese patent application are incorporated herein by reference.

### TECHNICAL FIELD

The present disclosure relates to an optical connection assembly, an optical connection component, and a method of manufacturing an optical connection assembly.

### BACKGROUND

For example, Patent Literature (U.S. Patent Application Publication No. 2016/0370544) discloses a positioning structure in which a ferrule holding a distal end portion of an optical fiber is positioned with respect to a receptacle disposed on an optical IC substrate by using guiding pins. In this positioning structure, a ferrule and a receptacle are positioned by inserting guiding pins protruding from the ferrule into guiding holes formed in the receptacle.

### SUMMARY

An optical connection assembly of the present disclosure includes a first optical connection component, a second optical connection component configured to be connected to the first optical connection component, and a positioning structure configured to maintain relative positions between the first optical connection component and the second optical connection component. The positioning structure includes a protrusion protruding from the first optical connection component, and a hole formed in the second optical connection component and into which the protrusion is inserted. An inner surface of the hole includes at least one projection projecting from the inner surface toward the protrusion.

### BRIEF DESCRIPTION OF THE DRAWINGS

FIG. 1 is a front view showing an optical connection assembly of an embodiment.

FIG. 2 is a cross-sectional view of the optical connection assembly taken along line II-II of FIG. 1.

FIG. 3 is a cross-sectional view of the optical connection assembly taken along line III-III of FIG. 1.

FIG. 4 is a side surface view showing the optical connection assembly of FIG. 1.

FIG. 5 is a cross-sectional view of the optical connection assembly taken along line V-V of FIG. 4.

FIG. 6 is a cross-sectional view of the optical connection assembly taken along line VI-VI of FIG. 4.

FIG. 7 is a cross-sectional view showing the vicinity of guiding holes of an adapter included in the optical connection assembly of FIG. 1.

FIG. 8 is an enlarged cross-sectional view showing a portion A of FIG. 7.

FIG. 9 is a cross-sectional view showing the vicinity of guiding holes before the guiding pins of FIG. 8 is inserted.

FIG. 10 is a cross-sectional view showing the vicinity of the guiding holes after the guiding pins of FIG. 8 has been inserted.

FIG. 11 is a flowchart showing an example of a method of manufacturing an optical connection assembly according to an embodiment.

FIG. 12 is a front view showing modification of an optical connection assembly.

FIG. 13 is a cross-sectional view showing a modification of the guiding holes of the adapter.

### DETAILED DESCRIPTION

In the positioning structure disclosed in the Patent Literature, in order to improve the positioning accuracy between the ferrule and the receptacle, it is considered to bring the inner diameter of the guiding hole as close as possible to the outer diameter of the guiding pin. However, in practice, since a dimensional tolerance is set for the inner diameter of the guiding hole in consideration of the influence of variations in the orientation of the guiding pin, the processing accuracy of the guiding hole, and the like, there is a limit to bringing the inner diameter of the guiding hole close to the outer diameter of the guiding pin. Thus, it is difficult to improve the positioning accuracy between the ferrule and the receptacle by such a method.

The present disclosure provides an optical connection assembly, an optical connection component, and a method of manufacturing an optical connection assembly, which can improve positioning accuracy.

### Description of Embodiments of Present Disclosure

First, the contents of the embodiments of the present disclosure will be listed and described.

(1) An optical connection assembly of the present disclosure includes a first optical connection component, a second optical connection component configured to be connected to the first optical connection component, and a positioning structure configured to maintain relative positions between the first optical connection component and the second optical connection component. The positioning structure includes a protrusion protruding from the first optical connection component, and a hole formed in the second optical connection component and into which the protrusion is inserted. An inner surface of the hole includes at least one projection projecting from the inner surface toward the protrusion.

In the optical connection assembly, the protrusion protruding from the first optical connection component is inserted into the hole of the second optical connection component, so that the relative position between the first optical connection component and the second optical connection component is maintained. The inner surface of the hole into which the protrusion is inserted includes at least one projection projecting from the inner surface toward the protrusion. In this case, the at least one projection can fill a gap between the protrusion and the inner surface of the hole, which is caused by the tolerance. Thus, since the positional displacement of the protrusion with respect to the hole can be reduced, the positional accuracy between the first optical connection component and the second optical connection component can be improved. Further, when the gap between the protrusion and the inner surface of the hole is filled by the at least one projection, even when the protrusion interferes with the at least one projection, the insertion of the protrusion into the hole can be reliably performed by the deformation of the at least one projection. Thus, according to the optical connection assembly, it is possible to improve the positional accuracy between the first optical connection component and the second optical connection component while reliably inserting the protrusion into the hole.

(2) In the optical connection assembly according to the above (1), a height of the at least one projection from the inner surface may be greater than or equal to a maximum value of a tolerance of an inner diameter of the hole. In this case, the gap between the protrusion and the inner surface of the hole can be more reliably filled by the at least one projection, and thus the positional displacement of the protrusion with respect to the hole can be more reliably reduced. Thus, the positional accuracy between the first optical connection component and the second optical connection component can be more reliably improved.

(3) In the optical connection assembly according to the above (1) or (2), hardness of the at least one projection may be lower than hardness of the protrusion. In this case, even when the protrusion interferes with the at least one projection of the inner surface of the hole when the protrusion is inserted into the hole, the at least one projection can be easily deformed by the protrusion, and thus the insertion of the protrusion into the hole can be more reliably performed.

(4) In the optical connection assembly according to any one of the above (1) to (3), the at least one projection may be made of a material capable of plastically deforming by receiving a pressing force from the protrusion. In this case, when the protrusion is inserted into the hole, the at least one projection is pressed by the protrusion and plastically deformed. As a result, at least one projection retains its shape in a pressed state due to the protrusion. In this case, even when the same protrusion is removed from the hole and inserted into the hole again, the hole is maintained in a shape matching the protrusion, and thus the protrusion can be easily positioned with respect to the hole.

(5) In the optical connection assembly according to any one of the above (1) to (4), the at least one projection may be in contact with the protrusion. In this case, the contact of the at least one projection with the protrusion can further reduce the positional displacement of the protrusion with respect to the hole. This can further improve the positional accuracy between the first optical connection component and the second optical connection component.

(6) In the optical connection assembly according to any one of the above (1) to (5), the at least one projection may be a plurality of projections. The plurality of projections may be arranged to be spaced apart from each other in a cross-section intersecting a direction in which the hole extends. In this case, even when the position and the orientation of the protrusion with respect to the hole are deviated in any direction, the deviation of the protrusion with respect to the hole can be absorbed by the deformation of the plurality of projections. Thus, the rattling of the protrusion in the hole can be more reliably reduced, and thus the positional accuracy between the first optical connection component and the second optical connection component can be more reliably improved.

(7) In the optical connection assembly according to any one of the above (1) to (6), the at least one projection may have a pair of side surfaces inclined to approach each other toward the protrusion in a cross-section perpendicular to a direction in which the hole extends. In this configuration, when the protrusion is inserted into the hole, at least one projection that interferes with the protrusion causes the distal end of at least one projection to be more likely pressed by the protrusion, making the insertion of the protrusion into the hole easier.

(8) In the optical connection assembly according to any one of the above (1) to (6), the at least one projection may have a pair of side surfaces inclined to separate from each other toward the protrusion in a cross-section perpendicular to a direction in which the hole extends. In this configuration, when the protrusion is inserted into the hole, at least one projection interferes with the protrusion, the portion from the distal end to the proximal end of the at least one projection can be pressed with a certain resistance by the protrusion, and thus the insertion of the protrusion into the hole can be smoothly performed without a sense of discomfort.

(9) In the optical connection assembly according to any one of the above (1) to (8), the protrusion may be a guiding pin fixed to the first optical connection component in a state in which the guiding pin is inserted into a hole of the first optical connection component. In this case, the first optical connection component and the second optical connection component can be easily positioned using the guiding pin.

(10) In the optical connection assembly according to any one of the above (1) to (9), the first optical connection component may be an optical connector including at least one optical waveguide. The second optical connection component may be an adapter placed on a circuit board including at least one optical input-output portion, and the adapter may be configured to connect the first optical connection component to the circuit board so as to optically couple the at least one optical waveguide to the at least one optical input-output portion. In this case, the at least one optical waveguide can be optically coupled to the at least one optical input-output portion of the circuit board with high accuracy by using the positioning structure including the protrusion and the hole.

(11) In the optical connection assembly according to any one of the above (1) to (9), the second optical connection component may be an optical connector including at least one optical waveguide. The first optical connection component may be an adapter placed on a circuit board including at least one optical input-output portion, and the adapter may be configured to connect the second optical connection component to the circuit board so as to optically couple the at least one optical waveguide to the at least one optical input-output portion. In this case, the at least one optical waveguide can be optically coupled to the at least one optical input-output portion of the circuit board with high accuracy by using the positioning structure including the protrusion and the hole.

(12) An optical connection component of the present disclosure is an optical connection component configured to be connected to a connection-target optical connection component in a state in which a relative position of the optical connection component with respect to the connection-target optical connection component is maintained. The optical connection component includes a hole configured to be able to maintain relative positions between the optical connection component and the connection-target optical connection component by allowing a protrusion protruding from the connection-target optical connection component to be inserted into the hole. An inner surface of the hole includes at least one projection. According to this optical connection component, when the optical connection component is connected to the connection-target of the optical connection component, as described above, the positional accuracy between the optical connection component and the connection-target optical connection component can be improved while reliably inserting the protrusion of the connection-target optical connection component into the hole of the optical connection component.

(13) A method of manufacturing an optical connection assembly of the present disclosure include preparing a first optical connection component including a protrusion, and a second optical connection component including a hole having an inner surface on which at least one projection is formed, inserting the protrusion into the hole including the at least one projection so as to maintain relative positions between the first optical connection component and the second optical connection component, and connecting the first optical connection component to the second optical connection component in a state in which the protrusion is inserted into the hole. According to the method of manufacturing an optical connection assembly, as described above, the positional accuracy between the first optical connection component and the second optical connection component can be improved while reliably inserting the protrusion of the first optical connection component into the hole of the second optical connection component.

### Details of Embodiments of Present Disclosure

Specific examples of an optical connection assembly, an optical connection component, and a method of manufacturing an optical connection assembly of the present disclosure will be described in detail below with reference to the accompanying drawings. The present invention is not limited to these examples, but is defined by the scope of the claims, and is intended to include all modifications within the meaning and scope equivalent to the scope of the claims. In the description of the drawings, the same elements are denoted by the same reference numerals, and redundant description will be omitted as appropriate.

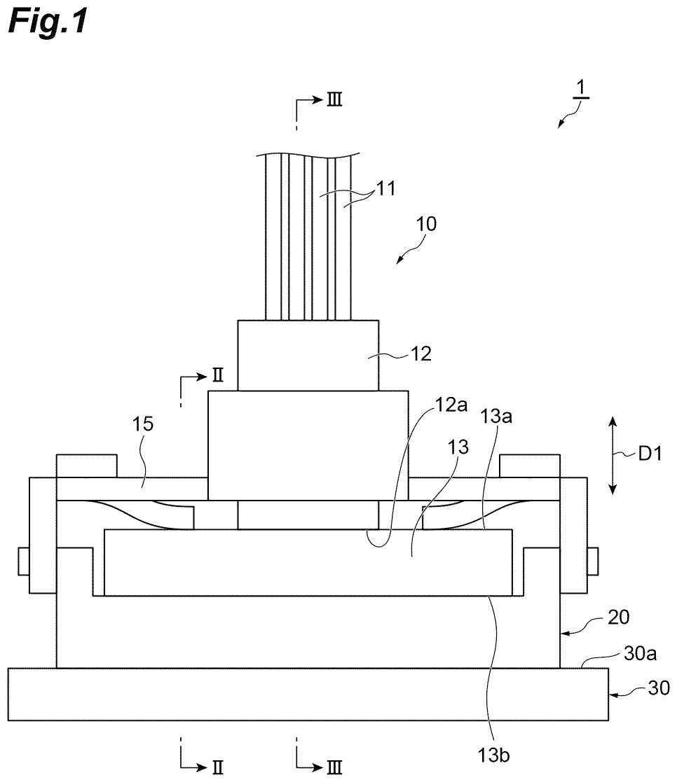

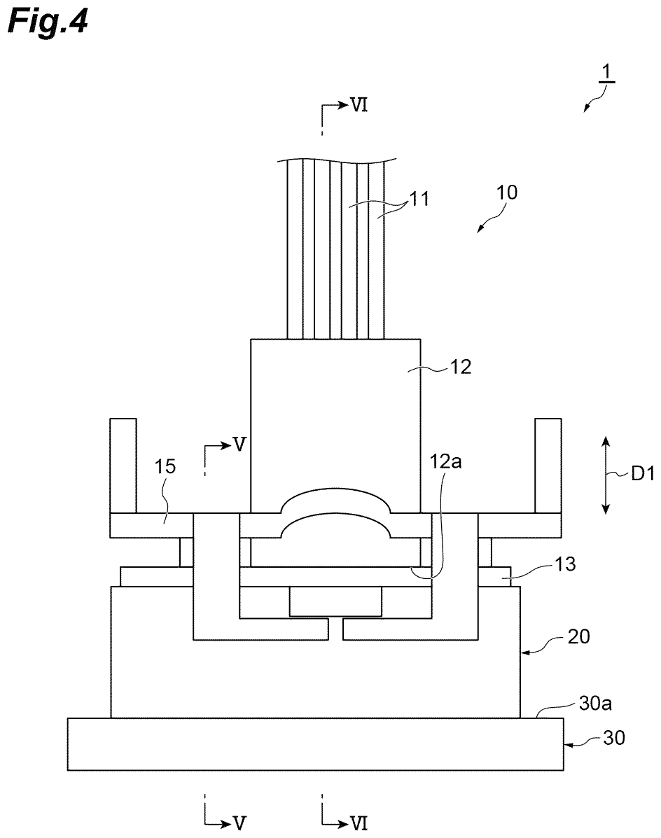

As shown in FIG. 1 to FIG. 6, an optical connection assembly 1 includes an optical connector 10 and an adapter 20.

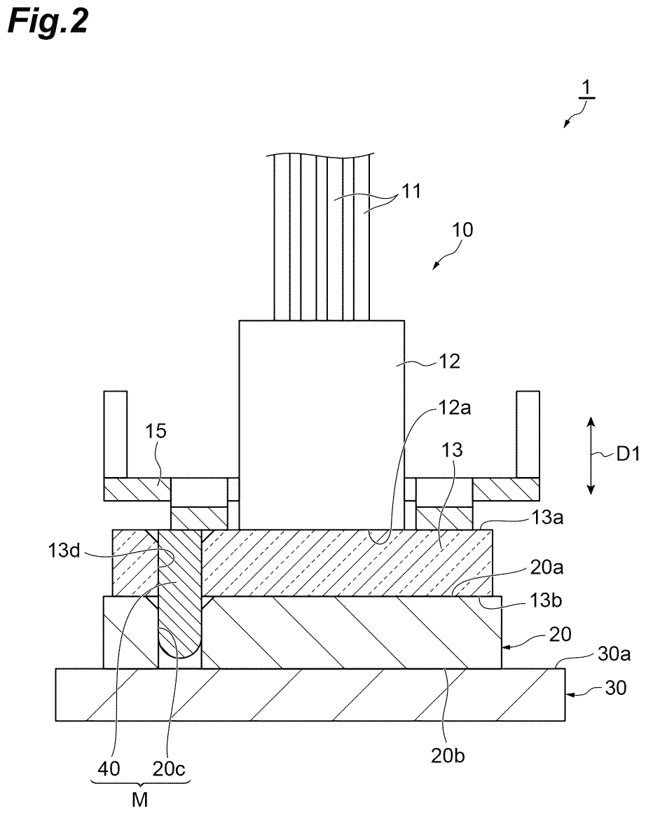

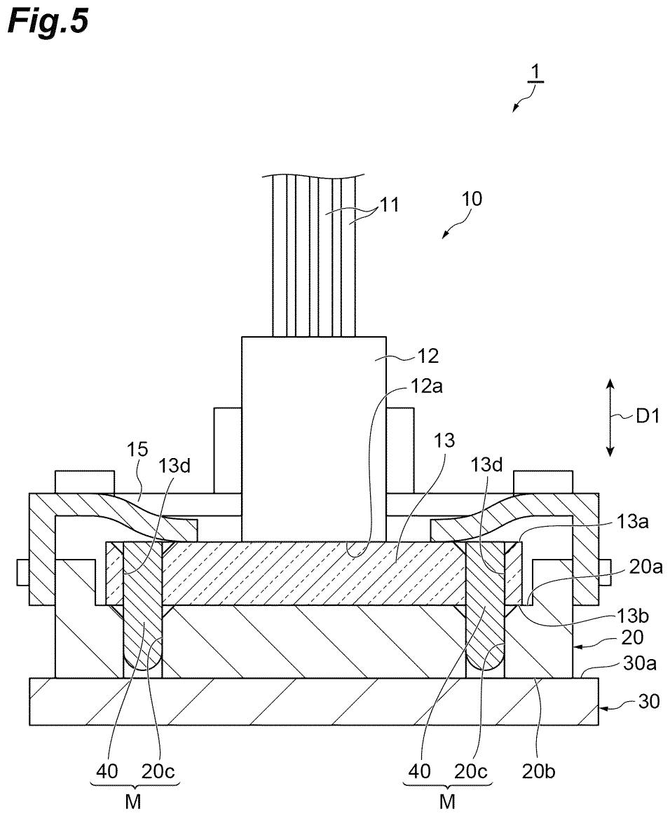

The adapter 20 is mounted on a main surface 30a of a circuit board 30. The optical connector 10 is disposed at a position facing the adapter 20 in a perpendicular direction D1. Then, the optical connector 10 is positioned relative to the adapter 20 in a state facing the perpendicular direction D1 by using a pair of guiding pins 40 shown in FIG. 2 and FIG. 5. The perpendicular direction D1 coincides with, for example, the normal direction of the main surface 30a.

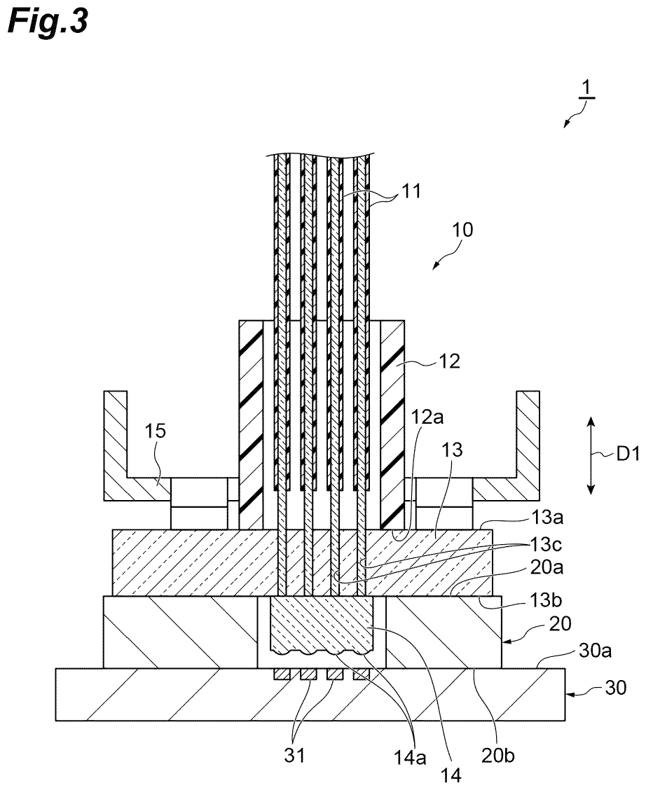

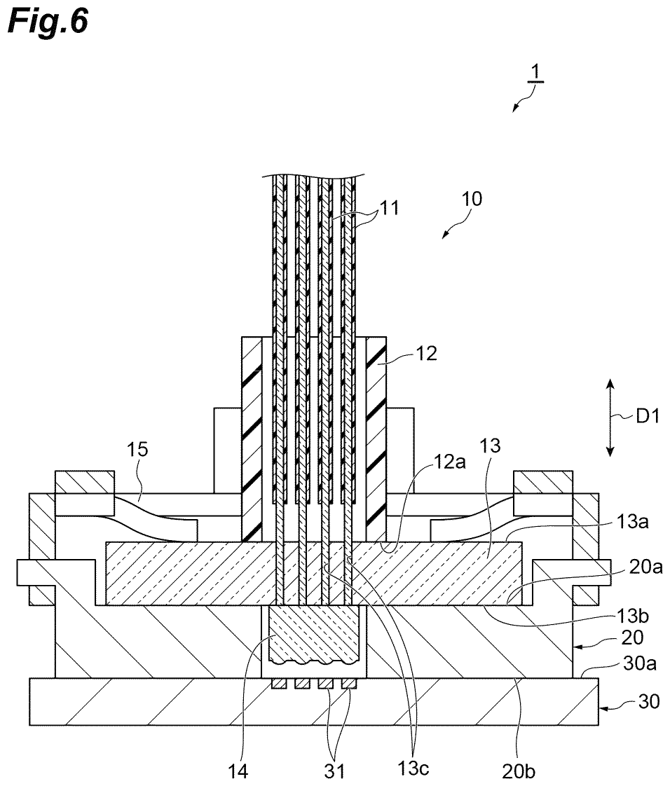

In this state, the optical connector 10 is connected to the adapter 20 along the perpendicular direction. As a result, as shown in FIG. 3 and FIG. 6, a plurality of optical fibers 11 provided in the optical connector 10 are optically coupled to a plurality of optical input-output portions 31 provided in the circuit board 30, respectively. The optical connector 10 and the adapter 20 may be relatively positioned in a state facing a horizontal direction intersecting the perpendicular direction D1, and may be connected along the horizontal direction.

The circuit board 30 includes the plurality of optical input-output portions 31 mounted on the main surface 30a. The material of the circuit board 30 is, for example, silicon, ceramic, or resin. Each of the plurality of optical input-output portions 31 is, for example, a grating coupler of an optical IC. Each of the plurality of optical input-output portions 31 are arranged two dimensionally on the main surface 30a and are exposed from the main surface 30a. Each optical input-output portion 31 is disposed to face each optical fiber 11 of the optical connector 10.

The optical connector 10 is an optical connection component connected to the adapter 20 mounted on the main surface 30a of the circuit board 30. The optical connector 10 includes, for example, the plurality of optical fibers 11, a protective member 12, a ferrule 13, a lens array 14, and a clip 15. The optical connector 10 may include a refractive index change region drawn inside a glass member as an optical waveguide instead of the plurality of optical fibers 11. The protective member 12 and the ferrule 13 may be integrally formed. That is, the protective member 12 and the ferrule 13 may be formed from a single member. The optical connector 10 need not include the lens array 14. In this case, the adapter 20 may include the lens array 14.

The plurality of optical fibers 11 are arranged in a two dimensional manner at a position facing the main surface 30a of the circuit board 30. The coated portions of the plurality of optical fibers 11 are held by the protective member 12. The coated portions of the plurality of optical fibers 11 are, for example, formed into a tape. The coating-removed portions of the plurality of optical fibers 11 protrude from a tip surface 12a of the protective member 12. The ferrule 13 is disposed on the tip surface 12a of the protective member 12.

The ferrule 13 may be a plate member made of a glass material. The ferrule 13 may be a member made of a resin material. The ferrule 13 includes a surface 13a facing the tip surface 12a of the protective member 12 in the perpendicular direction D1, a rear surface 13b facing the opposite side of the surface 13a, a plurality of fiber holes 13c penetrating from the surface 13a to the rear surface 13b in the perpendicular direction D1, and a pair of guiding holes 13d penetrating from the surface 13a to the rear surface 13b in the perpendicular direction D1.

As shown in FIG. 3 and FIG. 6, the plurality of fiber holes 13c are arranged in a two dimensional manner corresponding to the plurality of optical fibers 11 when viewed along the perpendicular direction D1. The coating-removed portions of the plurality of optical fibers 11 protruding from the tip surface 12a are inserted into the plurality of fiber holes 13c, respectively. The distal end portions of the plurality of optical fibers 11 are exposed from the rear surface 13b of the ferrule 13.

As shown in FIG. 2 and FIG. 5, a pair of guiding holes 13d are formed at a pair of positions of the ferrule 13 located outside the protective member 12 when viewed along the perpendicular direction D1. Each guiding hole 13d is, for example, a circular through hole extending along the perpendicular direction D1. The inner diameter of each guiding hole 13d is equal to or larger than the outer diameter of each guiding pin 40. The outer diameter of the guiding pin 40 may be, for example, 550 μm, and the tolerance of the outer diameter may be, for example, −20 μm to 20 μm (that is, ±20 μm). The outer diameter of the guiding pin 40 may be, for example, 548.3 μm to 548.7 μm. It is noted that, the outer diameter of the guiding pin 40 means the outer diameter of the proximal end (root) of the guiding pin 40, not the outer diameter of the distal end of the guiding pin 40. The inner diameter of the guiding hole 13d may be, for example, 549 μm to 550 μm.

Each guiding pin 40 is inserted into each guiding hole 13d. Each guiding pin 40 is fixed to an inner peripheral surface of each guiding hole 13d using, for example, an adhesive, in the state of being inserted into each guiding hole 13d. Thus, each guiding pin 40 is integral with the ferrule 13. For example, a C-chamfered portion is formed at a boundary portion between the surface 13a and the inner peripheral surface of each guiding hole 13d.

In a state in which the guiding pins 40 are inserted into the guiding holes 13d, the guiding pins 40 protrude from the rear surface 13b toward the adapter 20 in the perpendicular direction D1. Each guiding pin 40 is, for example, a columnar member and is made of a metal such as stainless steel (SUS). It is noted that, each guiding pin 40 is not limited to metal, and may be made of other materials such as resin. Further, each guiding hole 13d may have any shape that allows for a space to accommodate a portion of each guiding pin 40, and is not limited to a through hole; for example, it may also be a recess or a groove. Each guiding hole 13d may extend in a direction inclined, for example, by 8 degrees with respect to the perpendicular direction D1.

As shown in FIG. 3 and FIG. 6, the lens array 14 is disposed on the rear surface 13b of the ferrule 13. The lens array 14 includes a plurality of lens surfaces 14a optically coupled to the plurality of optical fibers, respectively. The plurality of lens surfaces 14a are disposed between the plurality of optical fibers 11 and the plurality of optical input-output portions 31. Each of the plurality of lens surfaces 14a is, for example, a collimating lens. Each lens surface 14a optically couples each optical fiber 11 exposed from the rear surface 13b of the ferrule 13 to each optical input-output portion 31 on the main surface 30a.

The clip 15 is, for example, made of metal such as sheet metal. The clip 15 is in contact with the ferrule 13 and is detachably attached to the adapter 20 in a state in which the ferrule 13 is sandwiched therebetween. The clip 15 maintains the connection state between the optical connector 10 and the adapter 20 when attached to the adapter 20.

The adapter 20 is a connection-target optical connection component for connecting the optical connector 10 to the circuit board 30. The adapter 20 is placed on the main surface 30a of the circuit board 30 and connected to the optical connector 10. The adapter 20 includes an upper surface 20a facing the rear surface 13b of the ferrule 13 in the perpendicular direction D1, a bottom surface 20b facing the main surface 30a of the circuit board 30 in the perpendicular direction D1, and a pair of guiding holes 20c penetrating from the upper surface 20a to the bottom surface 20b. The upper surface 20a is in contact with the rear surface 13b of the ferrule 13. The bottom surface 20b is in contact with the main surface 30a of the circuit board 30. For example, a C-chamfered portion is formed at a boundary portion between the upper surface 20a and the inner peripheral surface 20d of each guiding hole 20c.

As shown in FIGS. 2 and 5, each guiding hole 20c is formed at a position overlapping each guiding hole 13d of the ferrule 13 in the perpendicular direction D1. Each guiding hole 20c is, for example, a circular through hole extending along the perpendicular direction D1. The inner diameter of each guiding hole 20c is the same as the inner diameter of each guiding hole 13d. The inner diameter of the guiding hole 20c may be, for example, 550 μm, and the tolerance of the inner diameter may be, for example, −20 μm to 20 μm (that is, ±20 μm). The inner diameter of the guiding hole 20c may be, for example, 552 μm to 554 μm.

Each guiding pin 40 protruding from each guiding hole 13d in the perpendicular direction D1 is inserted into each guiding hole 20c. The optical connector 10 and the adapter 20 are positioned by inserting each guiding pin 40 into each guiding hole 20c. Thus, each guiding hole 20c and each guiding pin 40 form a positioning structure M for maintaining the relative position between the optical connector 10 and the adapter 20. Each guiding hole 20c is not limited to a through hole as long as it has a shape that secures a space for accommodating a part of the guiding pin 40, and may be, for example, a recess or a groove. Each guiding hole 20c may extend in a direction inclined, for example, by 8 degrees with respect to the perpendicular direction D1.

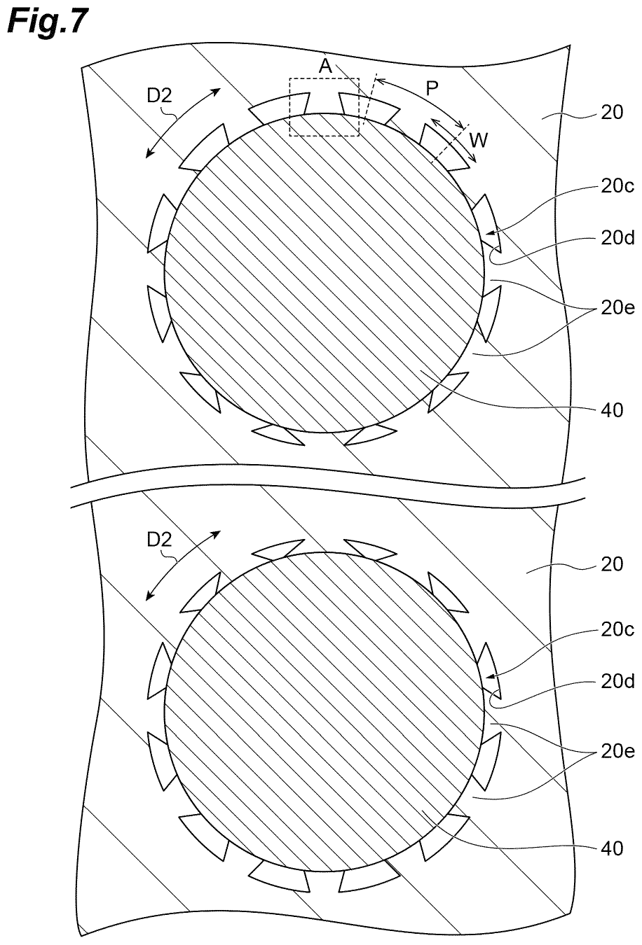

Referring to FIGS. 7 to 10, the positioning structure M including a pair of guiding holes 20c and a pair of guiding pins 40 will be described in more detail.

As shown in FIG. 7, the inner peripheral surface 20d of each guiding hole 20c includes a plurality of projections 20e. The plurality of projections 20e are arranged to be spaced apart from each other along a circumferential direction D2 in a cross-section perpendicular to the guiding hole 20c extending along the perpendicular direction D1, and protrude from the inner peripheral surface 20d toward the guiding pin 40. The circumferential direction D2 is a direction along a ring centered on the guiding hole 20c. The plurality of projections 20e are arranged at equal intervals along the circumferential direction D2, for example. At least one projection 20e of the plurality of projections 20e protrudes from the inner peripheral surface 20d and contacts the guiding pin 40. In the embodiment, all the projections 20e contacts the guiding pin 40.

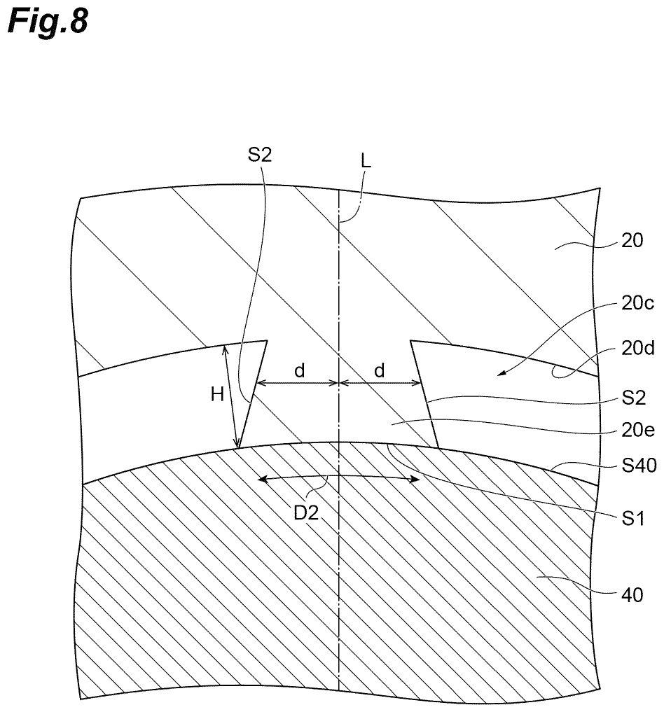

A pitch P (interval) of each projection 20e along the circumferential direction D2 may be, for example, constant. A width W of each projection 20e along the circumferential direction D2 may be greater than a height H (see FIG. 8) of the projection 20e from the inner peripheral surface 20d, for example.

As shown in FIG. 8, each of the plurality of projections 20e has a trapezoidal shape in which the width in the circumferential direction D2 increases toward the guiding pin 40, for example in a cross-section perpendicular to the guiding hole 20c. Each projection 20e includes a top surface S1 protruding from the inner peripheral surface 20d, and a pair of side surfaces S2 arranged along the circumferential direction D2 and connecting the inner peripheral surface 20d and the top surface S1.

The top surface S1 contacts an outer peripheral surface S40 of the guiding pin 40. For example, the entire top surface S1 is in contact with the outer peripheral surface S40 of the guiding pin 40 without a gap. The pair of side surfaces S2 are inclined away from each other in the circumferential direction D2 toward the guiding pin 40. In FIG. 8, when an imaginary line L connecting the center of the projection 20e along the circumferential direction D2 and the center of the guiding hole 20c is drawn, the side surface S2 is inclined with respect to the imaginary line L such that a distance d between the imaginary line L and the side surface S2 increases as it approaches the outer peripheral surface S40 of the guiding pin 40 from the inner peripheral surface 20d.

The distance from the inner peripheral surface 20d to the top surface S1, that is, the height H of the projection 20e from the inner peripheral surface 20d is set to be equal to or greater than the maximum value of the tolerance of the inner diameter of the guiding hole 20c. The tolerance of the inner diameter of the guiding hole 20c is, for example, ±1 μm. In this case, the height H of the projection 20e is set to be 1 μm or more, which is the maximum value of the tolerance of the inner diameter of the guiding hole 20c. The range of the height H of the projection 20e is, for example, 1 μm to 2 μm. Each projection 20e having the height H can be formed on the inner peripheral surface 20d by, for example, sandblasting. In this case, for example, the arithmetic average roughness Ra of the inner peripheral surface 20d is set to 1 μm to 2 μm. Each projection 20e may be formed by other processes, such as laser machining processes, for example.

At least a part of the adapter 20 including the plurality of projections 20e is made of, for example, a material having a lower hardness than the guiding pin 40. In the embodiment, the entire adapter 20 is made of a material having a lower hardness than the guiding pin 40. The “hardness” is an index indicating mechanical strength. “Hardness” may be determined by, for example, a Vickers hardness test, a Rockwell hardness test, or a durometer hardness test. The “hardness” is measured according to a method defined by, for example, JIS (Japanese Industrial Standard) or ISO (International Organization for Standardization).

The adapter 20 is made of, for example, a metal (for example, Kovar or aluminum) having a lower hardness than the guiding pin 40. The adapter 20 may be made of a material other than metal (for example, a resin material or a glass material) as long as the material has a lower hardness than the guiding pin 40. The material of the adapter 20 is selected from the materials capable of plastically deforming by receiving a pressing force from the guiding pin 40 when the guiding pin 40 is inserted into the guiding hole 20c. Thus, when the guiding pin 40 is inserted into the guiding hole 20c, the plurality of projections 20e of the inner peripheral surface 20d of the guiding hole 20c are pressed by the guiding pin 40. Further, in a state in which the plurality of projections 20e are pressed by the guiding pin 40, the shape of the plurality of projections 20e is maintained.

The example of FIG. 7 shows the case in which each guiding pin 40 is inserted into each guiding hole 20c with the center of each guiding pin 40 displaced from the center of each guiding hole 20c. Depending on the misalignment of the center of each guiding pin 40, the amount of deformation of the projection 20e pressed by the guiding pin 40 varies. For example, each guiding pin 40 is displaced toward each other, and the projection 20e located inside each guiding pin 40 has a large amount of deformation, while the projection 20e located outside each guiding pin 40 has a small amount of deformation. Thus, the shapes of the projections 20e are different from one another depending on the position along the circumferential direction D2.

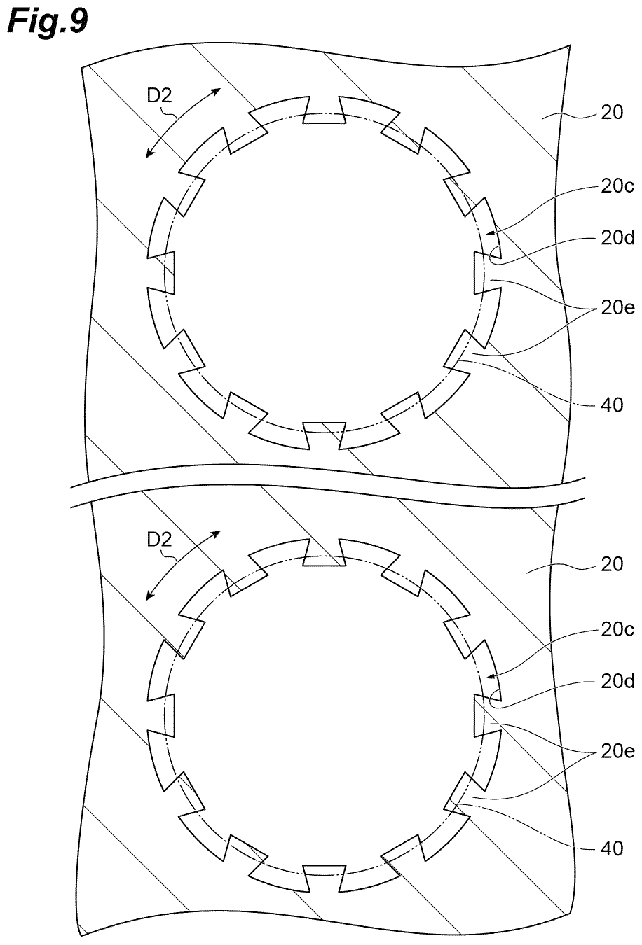

As shown in FIG. 9, in a state before each guiding pin 40 is inserted into each guiding hole 20c, the shapes of the projections 20e are the same as each other. In this state, the outer diameter of the inscribed circle inscribed in the top surface S1 of each projection 20e is set to be equal to or larger than the outer diameter of the guiding pin 40. In this case, when each guiding pin 40 is inserted into each guiding hole 20c, the guiding pin 40 interferes with each projection 20e. In FIG. 9, each guiding pin 40 inserted into each guiding hole 20c is shown by a two-dot chain line.

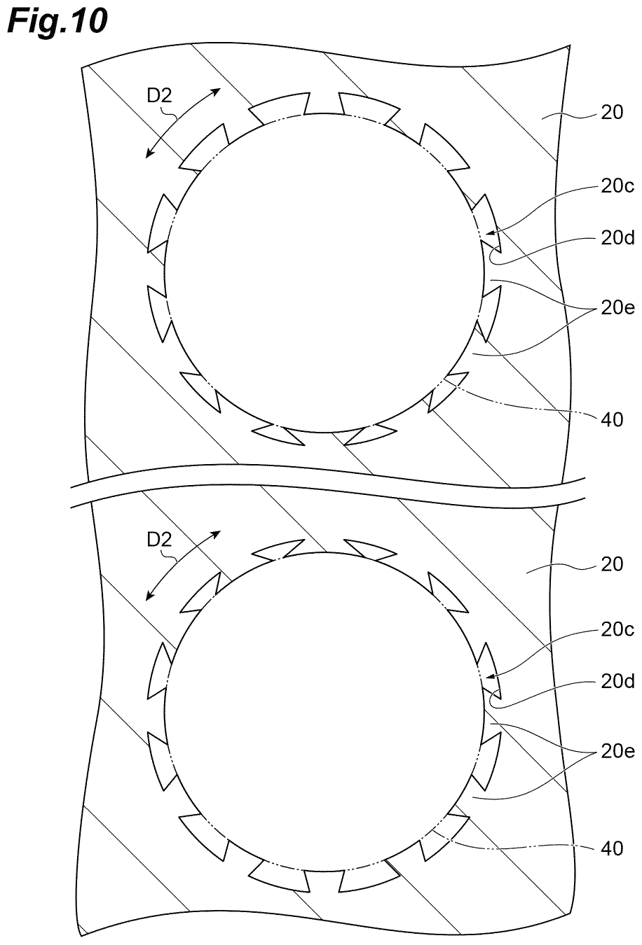

As shown in FIG. 10, each guiding pin 40 interferes with each projection 20e, so that each projection 20e is pressed and plastically deformed by each guiding pin 40. In this state, each projection 20e is in close contact with each guiding pin 40, and thus each guiding pin 40 is held in each projection 20e so as not to be displaced in each projection 20e. Thereafter, when each guiding pin 40 is removed from each guiding hole 20c, the shape of each projection 20e is maintained in a state in which each projection 20e is pressed by the each guiding pin 40. That is, each projection 20e is maintained in a shape corresponding to the shape of the guiding pin 40. Thus, the same guiding pin 40 can be easily attached to and detached from the guiding hole 20c.

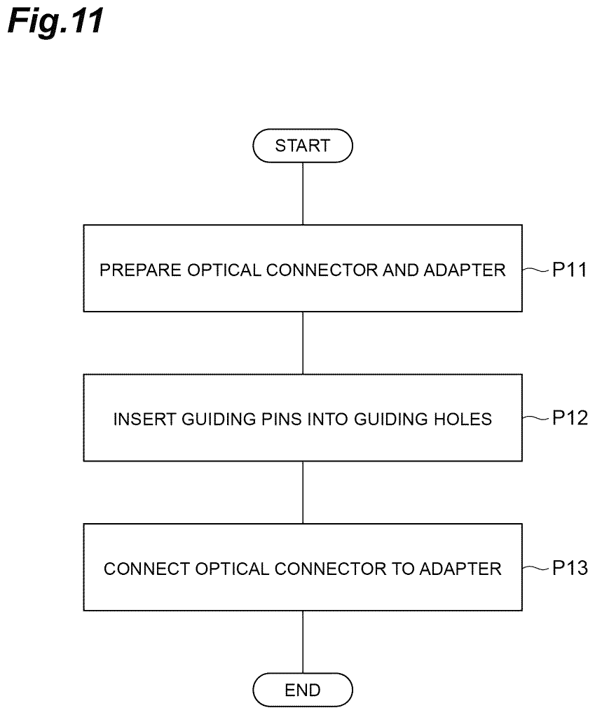

An example of a method of manufacturing the optical connection assembly 1 of the embodiment will be described with reference to FIG. 11.

First, the optical connector 10 and the adapter 20 described above are prepared (step P11). Each guiding hole 20c of the adapter 20 is formed by cutting the adapter 20 by laser machining, for example. Then, the inner peripheral surface 20d of each guiding hole 20c is subjected to sandblasting so that the arithmetic average roughness Ra is, for example, 1 μm to 2 μm, whereby the plurality of projections 20e are formed on the inner peripheral surface 20d. The plurality of projections 20e may be formed by other process, such as laser machining processes.

Next, the guiding pins 40 protruding from the optical connector 10 are inserted into the guiding holes 20c of the adapter 20 (step P12). When the guiding pin 40 is inserted into the guiding hole 20c, the plurality of projections 20e of the inner peripheral surface 20d of the guiding hole 20c are pressed and plastically deformed by the guiding pin 40. As a result, the plurality of projections 20e are in contact with the guiding pin 40 without a gap. Thus, the guiding pin 40 is in a state of being held in the plurality of projections 20e so as not to be displaced in the guiding hole 20c. As each guiding pin 40 is inserted into each guiding hole 20c, the relative position of the optical connector 10 with respect to the adapter 20 is maintained. That is, the optical connector 10 is positioned with respect to the adapter 20.

Next, the optical connector 10 is connected to the adapter 20 in a state where the relative position of the optical connector 10 with respect to the adapter 20 is maintained (step P13). For example, the optical connector 10 is connected to the adapter 20 by attaching the clip 15 of the optical connector 10 to the adapter 20. Thus, the plurality of optical fibers 11 of the optical connector 10 are optically coupled to the plurality of optical input-output portions 31 on the main surface 30a of the circuit board 30, respectively. In this manner, the optical connection assembly 1 in which the optical connector 10 is connected to the circuit board 30 by the adapter 20 is obtained.

After the optical connector 10 is connected to the adapter 20, the clip 15 of the optical connector 10 may be removed from the adapter 20, thereby pulling out each guiding pin 40 from each guiding hole 20c. As described above, as the guiding pin 40 is inserted into the guiding hole 20c, the plurality of projections 20e of each guiding hole 20c are plastically deformed according to the shape of the guiding pin 40. Thus, the plurality of projections 20e retain a shape that conforms to the shape of the guiding pin 40. It is noted that, when the plurality of projections 20e (or the adapter 20) are made of a material whose shape memory is strengthened by heating, a reflow process may be performed on the adapter 20 after each guiding pin 40 is pulled out from each guiding hole 20c. In this case, the shape of the plurality of projections 20e can be more reliably maintained in a shape matching the shape of the guiding pin 40.

Effects of the optical connection assembly 1, the optical connector 10, the adapter 20, and the method of manufacturing the optical connection assembly 1 of the embodiment will be described.

In the embodiment, each guiding pin 40 protruding from the optical connector 10 is inserted into each guiding hole 20c of the adapter 20, so that the relative position between the optical connector 10 and the adapter 20 is maintained. The inner peripheral surface 20d of each guiding hole 20c into which each guiding pin 40 is inserted includes the plurality of projections 20e protruding toward the guiding pin 40. In this case, the plurality of projections 20e can fill a gap between the guiding pin 40 and the inner peripheral surface 20d of the guiding hole 20c, which is caused by a tolerance. This reduces the positional displacement of the guiding pin 40 with respect to the guiding hole 20c, thereby improving the positional accuracy between the optical connector 10 and the adapter 20. Further, in the case where the gap between the guiding pin 40 and the inner peripheral surface 20d of the guiding hole 20c is filled by the plurality of projections 20e, even when the guiding pin 40 interferes with the plurality of projections 20e, the guiding pin 40 can be reliably inserted into the guiding hole 20c by the deformation of the plurality of projections 20e. Thus, according to the embodiment, the positioning accuracy between the optical connector 10 and the adapter 20 can be improved while the guiding pin 40 is reliably inserted into the guiding hole 20c.

As in the embodiment, the height H of each projection 20e from the inner peripheral surface 20d may be equal to or greater than the maximum value of the tolerance of the inner diameter of the guiding hole 20c. In this case, the plurality of projections 20e can more reliably fill the gap between the outer peripheral surface S40 of the guiding pin 40 and the inner peripheral surface 20d of the guiding hole 20c, and thus the positional displacement of the guiding pin 40 with respect to the guiding hole 20c can be more reliably reduced. This makes it possible to more reliably improve the positional accuracy between the optical connector 10 and the adapter 20.

As in the embodiment, the hardness of each projection 20e may be lower than the hardness of the guiding pin 40. In this case, even when the guiding pin 40 interferes with each projection 20e of the inner peripheral surface 20d of the guiding hole 20c when the guiding pin 40 is inserted into the guiding hole 20c, each projection 20e can be easily deformed by the guiding pin 40, and thus the guiding pin 40 can be more reliably inserted into the guiding hole 20c.

As in the embodiment, each projection 20e may be made of a material capable of plastically deforming by receiving a pressing force from the guiding pin 40. In this case, when the guiding pin 40 is inserted into the guiding hole 20c, each projection 20e is pressed by the guiding pin 40 and plastically deformed. As a result, each projection 20e retains its shape in a pressed state due to the guiding pin 40. In this case, even when the same guiding pin 40 is removed from the guiding hole 20c and inserted into the guiding hole 20c again, the guiding hole 20c is maintained in a shape that matches the guiding pin 40, and thus, the positioning of the guiding pin 40 with respect to the guiding hole 20c can be easily performed.

As in the embodiment, each projection 20e may be in contact with the guiding pin 40. In this case, the contact of each projection 20e with the guiding pin 40 can further reduce the positional displacement of the guiding pin 40 with respect to the guiding hole 20c. This can further improve the positional accuracy between the optical connector 10 and the adapter 20.

As in the embodiment, the projections 20e may be arranged to be spaced apart from each other in a cross-section intersecting the perpendicular direction D1. In this case, regardless of the direction in which the position and orientation of the guiding pin 40 are misaligned with respect to the guiding hole 20c, the deformation of each projection 20e can absorb the misalignment of the guiding pin 40 relative to the guiding hole 20c. This makes it possible to more reliably reduce the looseness of the guiding pin 40 in the guiding hole 20c, and thus to more reliably improve the positional accuracy between the optical connector 10 and the adapter 20.

As in the embodiment, each projection 20e may include a pair of side surfaces S2 inclined away from each other toward each guiding pin 40 in a cross-section perpendicular to the perpendicular direction D1. In this configuration, when the guiding pin 40 is inserted into the guiding hole 20c, when each projection 20e interferes with the guiding pin 40, the portion from the distal end to the proximal end of each projection 20e can be pressed with a certain resistance by the guiding pin 40, and thus the guiding pin 40 can be smoothly inserted into the guiding hole 20c without a sense of discomfort.

As in the embodiment, the guiding pin 40 may be fixed to the optical connector 10 in a state of being inserted into the guiding hole 13d of the optical connector 10. In this case, the optical connector 10 and the adapter 20 can be easily positioned using the guiding pin 40.

As in the embodiment, the optical connector 10 may include a pair of guiding pins 40, and the adapter 20 may include a pair of guiding holes 20c. In this case, the plurality of optical fibers 11 of the optical connector 10 can be optically coupled to the plurality of optical input-output portions 31 of the circuit board 30 with high accuracy, respectively, by using the positioning structure M including the pair of guiding pins 40 and the pair of guiding holes 20c.

The optical connection assembly, the optical connection component, and the method of manufacturing the optical connection assembly of the present disclosure are not limited to the above-described embodiments. The optical connection assembly, the optical connection component, and the method of manufacturing an optical connection assembly of the present disclosure may be modified in specific aspects without departing from the spirit of the claims.

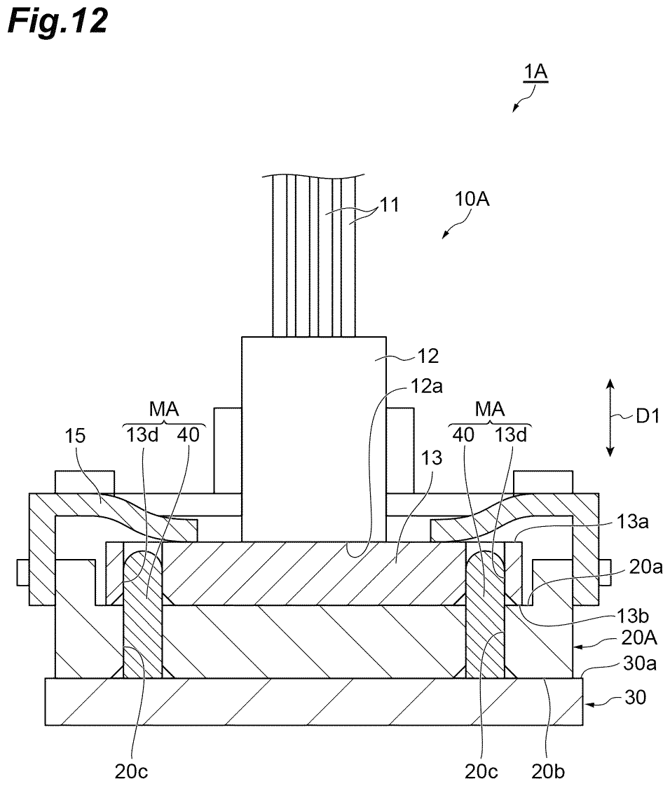

As in an optical connection assembly 1A shown in FIG. 12, a pair of guiding pins 40 may be fixed to an adapter 20A. In this case, the pair of guiding pins 40 are fixed to the adapter 20A in a state of being inserted into the pair of guiding holes 20c included in the adapter 20A. The pair of guiding pins 40 protrude from the upper surface 20a of the adapter 20A in the perpendicular direction D1 and are inserted into a pair of guiding holes 13d of the ferrule 13 included in an optical connector 10A, respectively. As a result, the relative position between the optical connector 10A and the adapter 20A is maintained.

As described above, in the optical connection assembly 1A, the adapter 20A includes a pair of guiding pins 40, and the pair of guiding pins 40 are inserted into the pair of guiding holes 13d included in the optical connector 10A, respectively. In this case, a pair of guiding pins 40 protruding from the adapter 20A and a pair of guiding holes 13d of the optical connector 10A form a positioning structure MA for maintaining the relative position between the optical connector 10A and the adapter 20A. Even with such an optical connection assembly 1A, the similar effects as those of the above-described embodiment can be obtained.

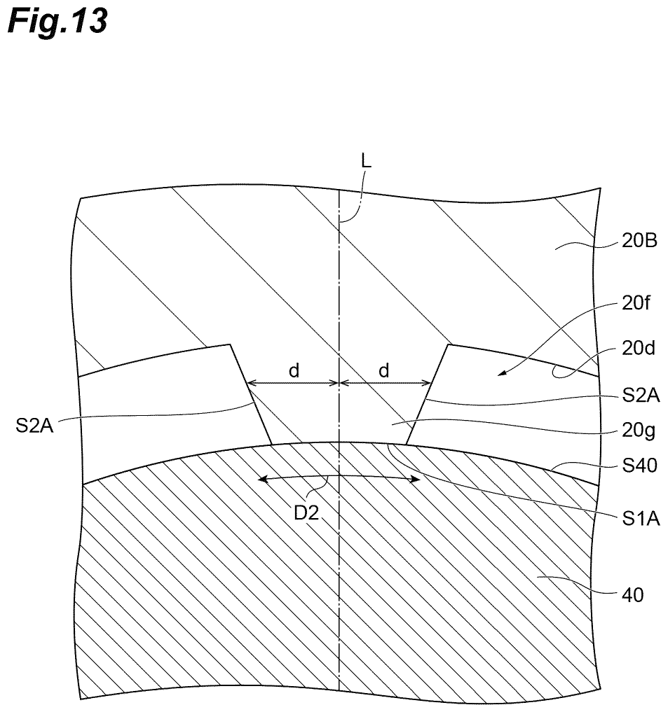

As in an adapter 20B shown in FIG. 13, a guiding hole 20f may include a plurality of projections 20g instead of the plurality of projections 20e. As shown in FIG. 13, each of a plurality of projections 20g has a trapezoidal shape in which the width in the circumferential direction D2 decreases toward the guiding pin 40, for example, in a cross-section perpendicular to the guiding hole 20f. Each projection 20g includes a top surface S1A protruding from the inner peripheral surface 20d, and a pair of side surfaces S2A arranged along the circumferential direction D2 and connecting the inner peripheral surface 20d and the top surface S1A.

The pair of side surfaces S2A are inclined so as to approach each other in the circumferential direction D2 toward the guiding pin 40. In FIG. 13, when an imaginary line L connecting the center of the projection 20g along the circumferential direction D2 and the center of the guiding hole 20f is drawn, the side surface S2A is inclined with respect to the imaginary line L such that the distance d between the imaginary line L and the side surface S2A decreases as it approaches the outer peripheral surface S40 of the guiding pin 40 from the inner peripheral surface 20d. Even with such an adapter 20B, the similar effects as those of the above-described embodiment can be obtained. Further, in the adapter 20B, when the guiding pin 40 is inserted into the guiding hole 20f, when the plurality of projections 20g interfere with the guiding pin 40, the distal end portions of the plurality of projections 20g are easily pressed by the guiding pin 40, and thus the guiding pin 40 can be more easily inserted into the guiding hole 20f.

The present disclosure is not limited to the above-described embodiments and modifications, and various other modifications are possible. For example, the above-described embodiments and each modification may be combined with each other as long as there is no contradiction, depending on the required purpose and effect. Although the inner peripheral surface 20d of the guiding hole 20c of the adapter 20 includes the plurality of projections 20e in the above-described embodiment, the inner peripheral surface of the guiding hole of the adapter may include one projection. In the above-described embodiment, the case where the adapter 20 is made of a material having a lower hardness than the guiding pin 40 has been described, but the adapter may be made of the same material as the guiding pin. In the above-described embodiment, the cross-sectional shape of the projection 20e of the guiding hole 20c of the adapter 20 is trapezoidal, but the cross-sectional shape of the projection may be other shapes such as rectangular, semi-cylindrical, hemispherical, or triangular.

What is claimed is:

1. An optical connection assembly comprising:
a first optical connection component;
a second optical connection component configured to be connected to the first optical connection component; and
a positioning structure configured to maintain relative positions between the first optical connection component and the second optical connection component,
wherein the positioning structure includes
a protrusion protruding from the first optical connection component, and
a hole formed in the second optical connection component and into which the protrusion is inserted, and
wherein an inner surface of the hole includes at least one projection projecting from the inner surface toward the protrusion.

2. The optical connection assembly according to claim 1,
wherein a height of the at least one projection from the inner surface is greater than or equal to a maximum value of a tolerance of an inner diameter of the hole.

3. The optical connection assembly according to claim 1,
wherein hardness of the at least one projection is lower than hardness of the protrusion.

4. The optical connection assembly according to claim 1,
wherein the at least one projection is made of a material capable of plastically deforming by receiving a pressing force from the protrusion.

5. The optical connection assembly according to claim 1,
wherein the at least one projection is in contact with the protrusion.

6. The optical connection assembly according to claim 1,
wherein the at least one projection is a plurality of projections, and
wherein the plurality of projections are arranged to be spaced apart from each other in a cross-section intersecting a direction in which the hole extends.

7. The optical connection assembly according to claim 1,
wherein the at least one projection has a pair of side surfaces inclined to approach each other toward the protrusion in a cross-section perpendicular to a direction in which the hole extends.

8. The optical connection assembly according to claim 1,
wherein the at least one projection has a pair of side surfaces inclined to separate from each other toward the protrusion in a cross-section perpendicular to a direction in which the hole extends.

9. The optical connection assembly according to claim 1,
wherein the protrusion is a guiding pin fixed to the first optical connection component in a state in which the guiding pin is inserted into a hole of the first optical connection component.

10. The optical connection assembly according to claim 1,
wherein the first optical connection component is an optical connector including at least one optical waveguide, and
wherein the second optical connection component is an adapter placed on a circuit board including at least one optical input-output portion, the adapter being configured to connect the first optical connection component to the circuit board so as to optically couple the at least one optical waveguide to the at least one optical input-output portion.

11. The optical connection assembly according to claim 1,
wherein the second optical connection component is an optical connector including at least one optical waveguide, and
wherein the first optical connection component is an adapter placed on a circuit board including at least one optical input-output portion, the adapter being configured to connect the second optical connection component to the circuit board so as to optically couple the at least one optical waveguide to the at least one optical input-output portion.

12. An optical connection component configured to be connected to a connection-target optical connection component in a state in which a relative position of the optical connection component with respect to the connection-target optical connection component is maintained, the optical connection component comprising:
a hole configured to be able to maintain relative positions between the optical connection component and the connection-target optical connection component by allowing a protrusion protruding from the connection-target optical connection component to be inserted into the hole,
wherein an inner surface of the hole includes at least one projection.

13. A method of manufacturing an optical connection assembly, the method comprising:
preparing a first optical connection component including a protrusion, and a second optical connection component including a hole having an inner surface on which at least one projection is formed;
inserting the protrusion into the hole including the at least one projection so as to maintain relative positions between the first optical connection component and the second optical connection component; and
connecting the first optical connection component to the second optical connection component in a state in which the protrusion is inserted into the hole.
